(19) United States
(12) Patent Application Publication
(10) Pub. No.: US 2007/0127240 A1
(43) Pub. Date: Jun. 7, 2007

(54) Light source device and projector

(75) Inventor: Masayuki Inamoto, Saitama-shi (JP)

Correspondence Address: BIRCH STEWART KOLASCH & BIRCH, PO BOX 747, FALLS CHURCH, VA, 22040-0747, US

(73) Assignee: Fujinon Corporation

(21) Appl. No.: 11/633,503

(22) Filed: Dec. 5, 2006

(30) Foreign Application Priority Data
Dec. 6, 2005 (JP) P2005-352370

(51) Int. Cl. F21V 13/14; F21V 9/16

(52) U.S. Cl. 362/242; 362/231

(57) ABSTRACT

An R-light optical system 14, a G-light optical system 15, and a B-light optical system 16 are disposed correspondingly to an R-light LED chip 11, a G-light LED chip 12, and a B-light LED chip 13, which emit an red light (R light), a green light (G light), and a blue light (B light), respectively. The R-light optical system 14, the G-light optical system 15, and the B-light optical system 16 are formed by combining a reflecting plate, a refractive lens, and a diffraction grating appropriately. The R-light optical system 14, the G-light optical system 15, and the B-light optical system 16 distribute all of the R light, the G light, and the B light, which are diffused widely, toward a cross dichroic prism 17.

### BACKGROUND OF THE INVENTION

1. Technical Field

The invention relates to a light source device including a lighting optical system, which is designed with a light distribution characteristic of a light source being considered, and a projector using the light source device.

2. Description of the Related Art

As a projector for displaying an image on a screen by projecting light including image information onto the screen, a DLP (digital light processor), which is a projector using a DMD(Digital Micro-mirror Device), and a liquid crystal projector using a liquid crystal panel have been known.

It is preferable that bright and uniform light is applied to the DLP and the liquid crystal projector. Accordingly, it is required that the light emitted from a light source has high brightness and a uniform intensity distribution. For this reason, a high-pressure mercury lamp has been used usually so far.

However, since the high-pressure mercury lamp requires a large and heavy drive circuit, it badly affects decrease in size and weight of a projector. Since the high-pressure mercury lamp takes time for start-up, it is difficult to promptly turn on the high-pressure mercury lamp. In addition, a lifetime of the high-pressure mercury lamp is short.

Therefore, in recent years, there were spread projectors using a light emitting diode (hereinafter, referred to as “LED”) chip as a light source, instead of the high-pressure mercury lamp. Since the LED chip is small and light, it is possible to decrease the size and weight of the projectors. In addition, since the emission brightness is enhanced with the recent development, the lifetime is long and the power consumption is low. Accordingly, the LED is suitable for a light source.

However, the light emitted from the LED chip is diffused broadly. For this reason, for example, various methods for effectively condensing diffused LED light have been proposed. For example, JP 2005-128236 A and JP 2004-111357 A disclose light source devices in which respective LED chips are inclined and fixed in order to condense light emitted from the LED chips to one point. Also, JP 2005-128234 A and JP 2004-111357 A disclose light source devices, which condense light emitted from the LED chips with a condensing lens.

By the way, the materials of the LED chips have high refractive indices. Accordingly, when light is emitted externally from the LED chips, the light reaching the chip surface at an angel smaller than the total reflection angle is totally reflected by the surface and thus does not exit externally. For this reason, a method of preventing the total reflection by forming a slope in the chip has been used. By forming the slope in the chip, the light can be output to the outside. However, the light distribution characteristic of light, which has been output to the outside, is greatly different from that of light just emitted from the LED chips. Furthermore, the chip material and the optimal chip shape are different depending on the emitted colors. Therefore, the light distribution characteristic greatly varies depending on the emitted colors. The variation in light distribution characteristic is not important when the light is used for direct view but may cause deterioration in optical utilization efficiency when the light is used for a illumination light source. In the light source devices disclosed in JP 2005-128236 A, JP 2005-128234 A and JP 2004-111357 A, illumination optical units are designed without the light distribution characteristic, which varies depending on the emitted colors, being considered. Therefore, it is not sufficient for enhancing the optical utilization efficiency. The “light distribution characteristic” means a light intensity distribution, which indicates a spatial distribution of light emitted from a light source.

### SUMMARY OF THE INVENTION

The invention provides a light source device and a projector, which can enhance light utilization efficiency in consideration of a light distribution characteristic, which varies depending on a chip shape and emitted colors.

According to an aspect of the invention, a light source device includes light-emitting elements and light distribution members. The light-emitting elements emit red light, green light and blue light, respectively. The light distribution members are disposed correspondingly to the solid light emitting elements. At least one of the light distribution members have a different configuration from those of the other of light distribution members. The at least one of the light distribution members is configured in accordance with a light distribution characteristic of corresponding one of the solid light emitting elements.

The at least one of the light distribution elements may be formed by combining a reflecting plate, a refractive lens and a diffraction grating appropriately.

According to another aspect of the invention, a projector includes the above-described light source, a light modulation unit and a projection optical system. The light modulation unit modulates light emitted from the light source device in accordance with a projection image. The projection optical system projects the light modulated by the light modulation unit.

In the light source device according to the invention, light, which are emitted widely from the solid light-emitting elements, can be distributed by the use of the light distribution members disposed correspondingly to the solid light-emitting elements, which emits the red light, the green light, and the blue light, respectively. In addition, since at least one of the light distribution members has a configuration different from those of the other light distribution members. The at least one of the light distribution members is configured in accordance with the light distribution characteristic of the corresponding one of the solid light emitting elements, which varies depending on the emitted colors and the shape of the solid light-emitting element. Therefore, it is possible to enhance the utilization efficiency of light of each solid light-emitting element.

The light, which are emitted widely from the solid light-emitting elements, can be distributed and the distributed light can be condensed or adjusted in the emission direction by properly combining the reflecting plate, the refractive lens, and the diffraction grating in the light distribution members. Therefore, it is possible to enhance utilization efficiency of light.

The utilization efficiency of light of the light source of the projector can be enhanced by mounting the light source device on the projector having the light modulation unit or the projection optical system. Therefore, it is possible to greatly enhance the light intensity of a projection image.

### BRIEF DESCRIPTION OF THE DRAWINGS

FIG. 1 is a schematic diagram illustrating the configuration of a DLP.

FIG. 2 is an explanatory diagram illustrating emission timings of an R-light, a G-light and a B-light.

FIG. 3 is an explanatory diagram illustrating a light distribution characteristic of an R-light LED chip.

FIG. 4 is an explanatory diagram illustrating an example of an R-light optical system formed in the R-light LED chip.

FIG. 5 is an explanatory diagram illustrating a light distribution characteristic of a G-light LED chip.

FIG. 6 is a cross-sectional view illustrating an example of a G-light optical system formed in the G-light LED chip.

FIG. 7 is an explanatory diagram illustrating a light distribution characteristic of a B-light LED chip.

FIG. 8 is a cross-sectional view illustrating an example of a B-light optical system formed in the B-light LED chip.

FIG. 9 is an explanatory diagram illustrating an example of a DLP, which condenses light to a rod integrator by inclining and fixing an LED chip.

FIG. 10 is an explanatory diagram illustrating an example of a liquid crystal projector in which an LCD is disposed between an LED chip and a dichroic prism.

### DETAILED DESCRIPTION OF EMBODIMENTS OF THE INVENTION

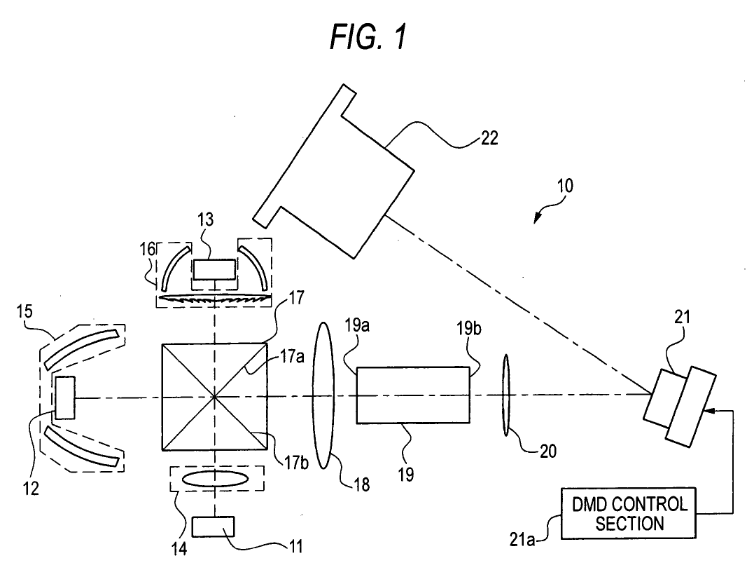

As shown in FIG. 1, a DLP (digital light processing) 10 includes: an R-light LED chip 11 (solid light-emitting element) for emitting R light (red); a G-light LED chip 12 (solid light-emitting element) for emitting G light (green); a B-light LED chip 13 (solid light-emitting element) for emitting B light (blue); an R-light optical system 14 (light distribution member) for the R-light LED chip 11; a G-light optical system 15 (light distribution member) for the G-light LED chip 12; a B-light optical system 16 (light distribution member) for the B-light LED chip 13; a cross dichroic prism 17; a condenser lens 18; a rod integrator 19; a relay lens 20; a DMD 21 (light modulation unit); and a projection lens 22 (projection optical system).

The R, G, and B light emitted from the R-light LED chip 11, the G-light LED chip 12, and the B-light LED chip 13 are all incident on the cross dichroic prism 17 through the R-light optical system 14, the G-light optical system 15, and the B-light optical system 16. The cross dichroic prism 17 are formed by combining four rectangular prisms. The cross dichroic prism 17 has two kinds of dichroic planes, that is, a R-light reflecting plane 17a for reflecting R light and a B-light reflecting plane 17b for reflecting B light. The rectangular prisms are disposed so that the R-light reflecting plane 17a and the B-light reflecting plane 17b are perpendicular to each other.

The light emitted from the cross dichroic prism 17 is incident on the condenser lens 18 and is condensed to an entrance plane 19a of the rod integrator 19 by the condenser lens 18. The light incident on the rod integrator 19 is repeatedly subjected to the total reflection and thus is superposed. Accordingly, the light exiting from an exit plane 19b is uniform in intensity distribution. The light exiting from the rod integrator 19 is incident on the relay lens 20 and is relayed to the DMD 21. The DMD 21 is driven by a DMD control section 21a. In the DMD 21, plural mirror elements corresponding to pixels are arranged in a matrix shape on a light-receiving plane. The mirror elements vary the reflection direction of the incident light by varying their angles by the use of the DMD control section 21a. When the pixels are displayed bright, the mirror elements are displaced to ON positions and the incident light is reflected as image light to the projection lens 22. The projection lens 22 enlarges and projects the image light reflected by the DMD 21 onto a screen (not shown). Accordingly, image information is displayed on the screen.

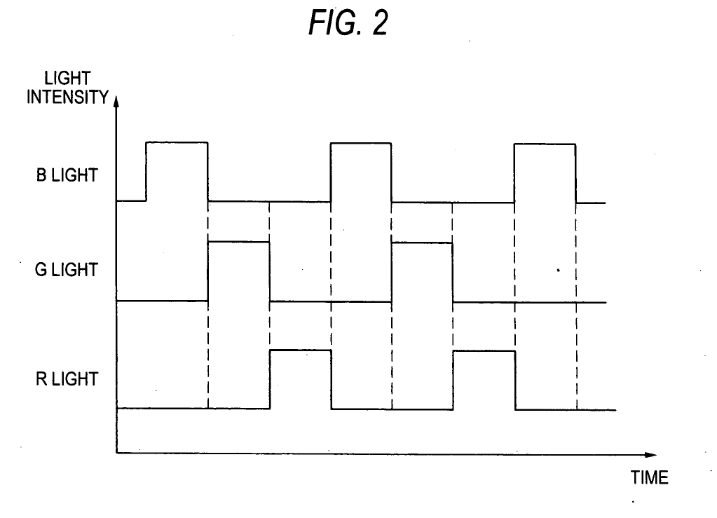

FIG. 2 shows a diagram illustrating emission timings of the R-light LED chip 11, the G-light LED chip 12, and the B-light LED chip 13. In the emission timing diagram, the horizontal axis denotes time and the vertical axis denotes light intensity. Two or more of the R, G, and B light are not simultaneously emitted, but are emitted in a surface-sequential order in which the G light is emitted at the time as extinguishing the B light, the R light is emitted at the same time as extinguishing the G light, and the B light is emitted at the same time as extinguishing the R light. The emission timing, the order of colors, and the light intensity may be changed so long as two or more lights are not simultaneously emitted.

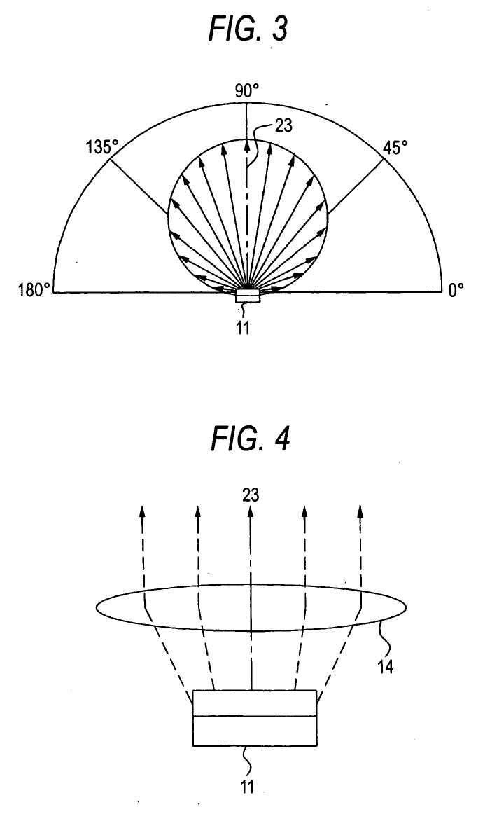

Next, the light distribution characteristic is shown in FIG. 3. In the light distribution characteristic, the direction of the R-light emission axis 23 of the R-light LED chip 11 is defined as 90°, the right direction of the R-light LED chip 11 is defined as 0°, and the left direction is defined as 180°. The R light emitted from the R-light LED chip 11 has the largest intensity in the direction of 90° and decreases in intensity as it goes toward the periphery from the direction of 90° (the portion surrounded by a solid line in FIG. 3 indicates the intensity distribution of the emitted R light). For this reason, the R light emitted from the R-light LED chip 11 is bright at the center thereof and becomes dark as it goes toward the periphery. Accordingly, as shown in FIG. 4, the R-light optical system 14 is disposed in the direction of the R-light emission axis 23 with respect to the R-light LED chip 11.

The R-light optical system 14 includes a refractive lens and enhances the intensity of the R light at the dark portion by refracting the incident R light so that the R light emitted widely is parallel to the R-light emission axis 23. Accordingly, it is possible to obtain the R light with high brightness and uniform brightness.

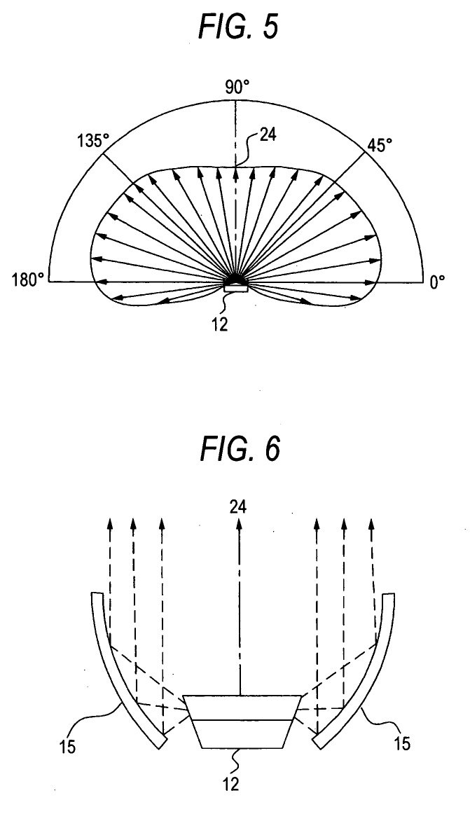

Similarly, the light distribution characteristic for the G-light LED chip 12 is shown in FIG. 5. The G light emitted from the G-light LED chip 12 is emitted to the rear side of the G-light LED chip 12 as well as being emitted forwardly (the portion surrounded by a solid line in FIG. 5 indicates the intensity distribution of the emitted G light). Since the G light emitted backwardly is not incident on the dichroic prism shown in FIG. 1 but leaked externally, the utilization efficiency of light is reduced. For this reason, as shown in FIG. 6, the G-light optical system 15 is formed to surround the G-light LED chip 12. The G-light optical system 15 includes a reflector (reflecting plate) formed on a parabolic surface and reflects the G light, which is emitted widely and includes the G light backwardly, so as to be parallel to the G-light emission axis 24. Accordingly, it is possible to enhance the utilization efficiency of the G light.

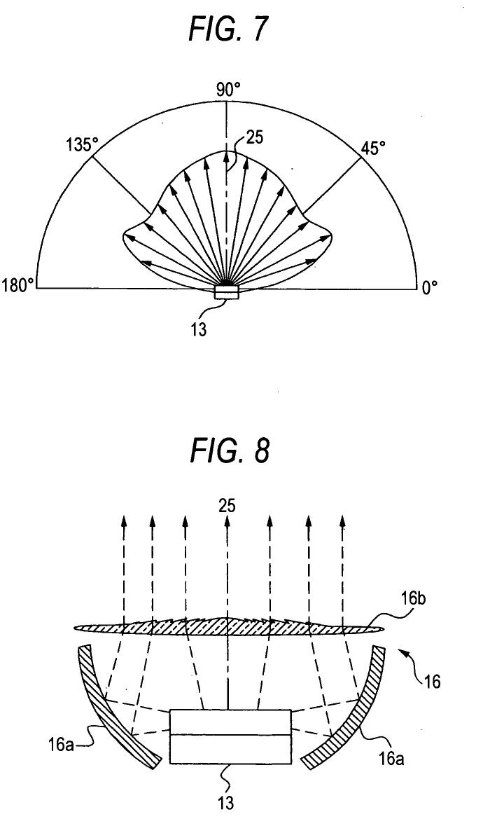

Similarly, the light distribution characteristic for the B-light LED chip 13 is shown in FIG. 7. The B light emitted from the B-light LED chip 13 has the largest intensity in the directions of 30 °, 90°, and 150° and the light intensity becomes smaller as it goes toward the periphery (the portion surrounded by the solid line in FIG. 7 indicates the light intensity distribution). In this case, since the B light, which is emitted in the directions of 30° and 150°, are not incident on the dichroic prism shown in FIG. 1 but may be leaked externally, the utilization efficiency of light is reduced. Accordingly, the B-light optical system 16 is formed as shown in FIG. 8.

The B-light optical system 16 includes a reflector 16a having a parabolic shape to surround the B-light LED chip 13 and a diffraction grating 16b formed in the direction of the B-light emission axis, and deflects the B light, which is emitted in the directions of 30° and 150°with high intensity from the B-light LED chip 13, toward the B-light emission axis 25. In the B-light LED chip 13, since the B light emitted laterally or backwardly is small and is emitted widely forwardly, it is possible to make the B lights be parallel to the B-light emission axis 25.

As described above, the R-light optical system 14, the G-light optical system 15 and the B-light optical system 16 are respectively provided in response to the R-light LED chip 14, the G-light LED chip 15 and the B-light LED chip 16, which have different light distribution characteristics. Therefore, it is possible to deflect a part of light, which is widely emitted, in one direction. Also, it is possible to make the light intensity distribution uniform and to align the deflected light with the emission axes 23 to 25. Accordingly, it is possible to greatly enhance the utilization efficiency of light.

The light distribution characteristics of the R-light LED chip 11, the G-light LED chip 12, and the B-light LED chip 13 described in the embodiment are only an example and the light source device according to the invention employs optical systems corresponding to the light distribution characteristics of the LED chips to be used.

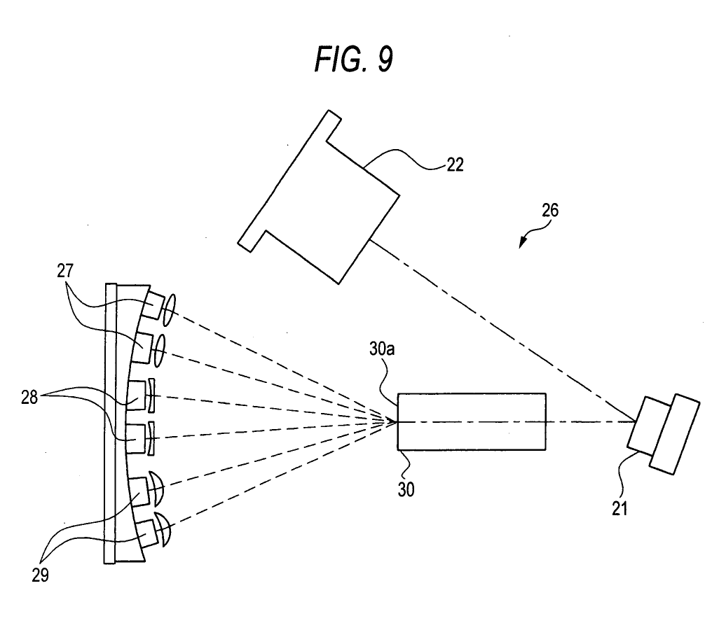

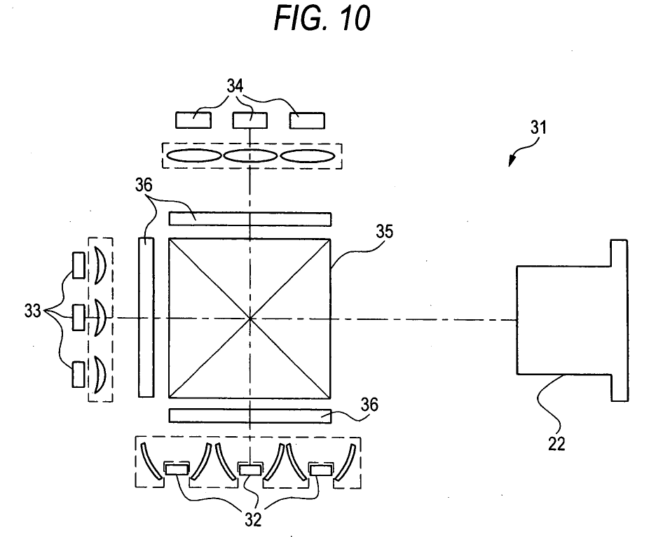

Although the DLP using the dichroic prism 17 has been described in the embodiment of the invention, the invention may be applied when lights are condensed on an entrance plane 30a of the rod integrator 30 by inclining and fixing the R-light LED chip 27, the G-light LED chip 28, and the B-light LED chip 29, respectively, for example, like the DLP 26 shown in FIG. 9 or when the LCDs 36 (light modulation means) are formed between the dichroic prism 35 and the R-light LED chip 32, the G-light LED chip 33, and the B-light LED chip 34, like the liquid crystal projector 31 shown in FIG. 10. In case of the liquid crystal projector 31 shown in FIG. 10, since the image information is loaded to the R light, the G light, and the B light by the LCDs 36, the R-light LED chip 32, the G-light LED chip 33, and the B-light LED chip 34 do not emit light in the surface-sequential order, but emit light in a continuous lighting manner in which three color components are always emitted.

What is claimed is:

1. A light source device comprising:
light-emitting elements that emit red light, green light and blue light, respectively; and
light distribution members, which are disposed correspondingly to the solid light emitting elements, wherein:
at least one of the light distribution members have a different configuration from those of the other of light distribution members, and
the at least one of the light distribution members is configured in accordance with a light distribution characteristic of corresponding one of the solid light emitting elements.

2. The device according to claim 1, wherein the at least one of the light distribution elements is formed by combining a reflecting plate, a refractive lens and a diffraction grating appropriately.

3. A projector comprising:
the light source device according to claim 1;
a light modulation unit that modulates light emitted from the light source device in accordance with a projection image; and
a projection optical system that projects the light modulated by the light modulation unit.

4. The projector according to claim 3, wherein the at least one of the light distribution elements of the light source device is formed by combining a reflecting plate, a refractive lens and a diffraction grating appropriately.
